(19) United States
(12) Patent Application Publication
(10) Pub. No.: US 2011/0256497 A1
(43) Pub. Date: Oct. 20, 2011

(54) Dental Tools for Photo-Curing of Dental Fillings

(76) Inventors: Alan Wong, Federal Heights, CO (US); H. Steven Rosen, Denver, CO (US)

(21) Appl. No.: 12/763,159

(22) Filed: Apr. 19, 2010

(51) Int. Cl. A61C 19/00; A61C 5/04

(52) U.S. Cl. 433/29; 433/89

(57) ABSTRACT

A dental tool for use in photo-cured filling processes. The dental tool includes a tool tip formed from a material that allows the transmission of ultraviolet and visible light wavelengths through the tool tip without significant distortion or reflection. The material is also relatively high strength so not to shatter or break during use. The fill material will also not adhere to the tool. The material of a preferred embodiment is sapphire. The tool is able to continue to compact and shape the fill material while the composite polymer fill material is undergoing photo-curing. The light beam used for photo-curing is able to safely pass through the tool without the risk of damage to the surrounding tissue from reflection or distortion of the light beam.

### FIELD OF THE INVENTION

This invention relates to the field of tools for dentistry.

### BACKGROUND OF THE INVENTION

Dental fillings have been commonly used for centuries to fill cavities in teeth. Traditionally, amalgam fillings were commonly used as dental fillings for decades. Amalgam fillings include two or more metals of which one is mercury usually in the range of 40-50 percent. While these fillings have been in common use for over 150 years, there are a number of concerns with the use of mercury. Mercury, while generally considered safe for use in dental amalgans does raise safety concerns both in use and in disposal later. Also, amalgam fillings tend to discolor over time as well as being noticeable.

Composite fillings have become more popular replacing amalgam fillings. Composite fillings are typically a mixture of acrylic resins and glass-like powders. These fillings can be self hardening but are more commonly cured with the use of ultraviolet rays. Composite fillings can be matched closely with the color of existing teeth, are relatively durable and moderate in price. The placement of the composite fillings into the cavities of the tooth can be difficult in order to eliminate any air pockets or other voids where bacteria might be able to grow.

Other types of fillings include inomer fillings, porcelain fillings, ceramics, cast gold, and others. These fillings have a variety of problems associated with them and typically are not as commonly used as composites.

The process of filling a cavity with a composite filling requires initial preparation of the cavity by removing any decay and cleaning the cavity. Then thin layers of the composite are applied repeatedly with photo curing of each layer prior to the application of the next layer. Once the cavity has been filled with the layers of polymer, the final layer is shaped to the desired result, any excess material is trimmed and the final result is polished.

The layers of polymer are hardened through photopolymerization. This process entails the use of a focused beam of light, usually ultraviolet or visible light. Typically, an ultraviolet beam is focused on the applied layer of polymer which activates the resin causing the layer to harden. The polymer will shrink some during the photopolymerization process. Since voids in the cavity can lead to bacteria growth, it is critical to eliminate any such voids. Thus the need for multiple thin layers of polymers. Also, the polymer must be manipulated into the cavity which is a relatively small space to ensure that no voids are created in the filling. Skilled dentists can ensure that the polymer material is properly applied by the feel of the dental tools applying and manipulating the polymer material in the cavity as well as by visual inspection of the site.

Most dental tools are formed from stainless steel or plastic materials. These materials reflect or otherwise interfere with the ultraviolet or visible light rays that not only causes inappropriate curing, but can also create damage to surrounding tissue in the mouth. Thus, dental tools are typically not able to be used during the actual photo-curing process. Another problem that often occurs with stainless steel and plastic materials is the adhesion of composite fill material to those materials. This creates additional problems in attempting to compact and shape the fill material not only during the curing process but even before the cure process. The adhesion of the composite fill material to the tool causes ripping of the material from the cavity and the creation of voids in the fill.

### SUMMARY OF THE INVENTION

The present invention provides dental tools that can be safely used to manipulate and compact polymer fillings not only prior to the curing process but during the curing process. The dental tool does not distort or reflect the transmission of ultraviolet or visible light used to cure the polymers in the cavity. The ability to be used during the photo-curing process enables the polymer to be compacted and shaped as the polymer shrinks, thus minimizing the occurrence of voids in the filling. This increases the efficiency of the process, reducing the time the patient must endure the filling process and minimizing the possibility of bacteria growth and infections.

The dental tool of a preferred embodiment uses a tool tip that has at least a portion formed from a material that allows the transmission of ultraviolet wavelengths (200-400 nm) and visible wavelengths (380-760 nm) through the portion of the tool tip without distortion or reflection of the wavelengths. This reduces the risk of damage to the tooth or surrounding tissue. The material also has a relatively high tensile strength so not to break or shatter during use. The entire tool tip may be formed from this material, or only the working portion of the tool tip may be formed from this material.

In one preferred embodiment, the tool tip of the dental tool is formed from sapphire. Sapphire has a high degree of transmission of wavelengths in the 150-800 nm range. Sapphire also has a relatively high tensile strength (275-400 Mpa) compared to most optical materials, so that it is durable and resistant to shattering or breaking during use. While sapphire (Al₂O₃) is found naturally, it is also able to produced artificially at a reasonable cost. It may also be grown, formed or machined into different shapes as well. The entire tool tip may be formed from sapphire or only the working area of the tool tip may be formed from sapphire.

The dental tool of a preferred embodiment provides a plurality of tool tips that may be attached to a gripping member. This enables the tool tips to be selected for particular uses while other tool tips have other uses. It also enables the tool to be used with opaque tool tips when a photo-curing process is not being used. The tool may also include tool tips on opposing ends of the tool so that the tool can simply be reversed when another tool tip is needed.

The dental tool of a preferred embodiment is used during a photo-curing filling process. For example, the cavity of a tooth is prepared for filling by removing decay and shaping the cavity. Then a thin layer of composite polymer fill material is applied to the cavity by the dental tool (or another dental tool). An light beam of ultraviolet (or visible light) wavelength is then directed to the fill material in the cavity. The dental tool is then used to further compact and shape the fill material as the fill material shrinks during the photo-curing process. The light beam is able to safely pass through the tool tip with only minimal distortion or reflection. Previously, the fill material would shrink and create voids in the fill material as it was unsafe to use existing tools. Then the dentist would attempt to fill the voids with additional fill material and to further shape the fill material. The tool of the present invention enables the fill material to be compacted and shaped while it is curing and shrinking. This provides a much more efficient process and one that minimizes the occurrence of voids in the fill material.

The tool of a preferred embodiment increases the efficiency of the cavity filling process. The ability to compact, manipulate and shape the fill material before and during the photo-curing process to eliminate voids from occurring while the material shrinks during the curing process greatly speeds up the fill process. Previous tools could not be used during the curing process so that voids would occur when the fill material shrank. The fill material would then have to be applied to the voids and cured, which could result in more voids occurring. This increases the time necessary to fill the cavity, decreasing the productivity of the dentist and increasing the discomfort to the patient. The tool of the present invention decreases the amount of time necessary to fill the cavity by allowing the fill material to be compacted and shaped during the photo-curing process. The ability of the tool to shed the fill material also increases the efficiency since the fill material will remain in place in the cavity.

These and other features of the present invention will be evident from the ensuing detailed description of preferred embodiments, from the drawings and the from the claims.

### BRIEF DESCRIPTION OF THE DRAWINGS

FIG. 1 is a perspective view of the dental tool of a preferred embodiment of the present invention.

FIG. 2 is a detail view of the tool tip of the tool of FIG. 1.

FIG. 3 is a detail view of a dental tool collet chuck.

FIG. 4 is a view of the dental tool in use.

FIG. 5 is a perspective view of the dental tool with a different tool tip.

FIG. 6 is a perspective view of another tool tip.

### DETAILED DESCRIPTION OF PREFERRED EMBODIMENTS

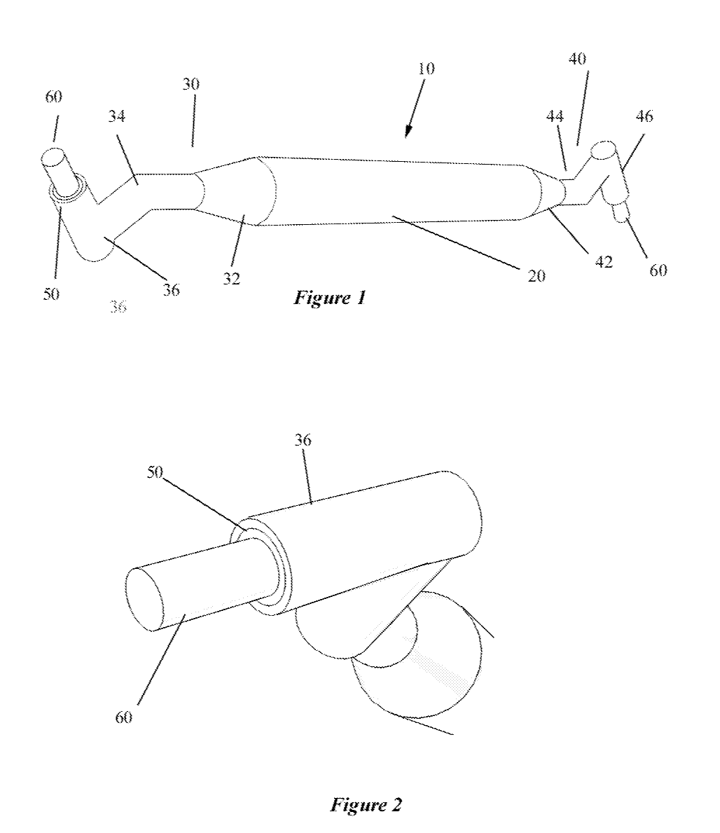

A preferred embodiment of the present invention is illustrated in FIGS. 1-6. It is to be expressly understood that the descriptive embodiments are provided herein for explanatory purposes only and are not meant to unduly limit the claimed inventions. The exemplary embodiments describe the present invention in terms of dental tools, but it is to be made clear that the claimed invention encompasses other forms of tools where ultraviolet as well as other light sources are used. Also, the claimed invention may be used for tools where any one or combinations of the high optical transmission rates, the high strength and resistance to fracture or shattering and the ability to shed or prevent adherence of other materials are important.

The present invention provides a tool that can be used for manipulating and compacting composite fill materials in a cavity of a tooth not only prior to the curing process but also during the actual curing process. The dental tool is used with ultraviolet (light in the range of ten to four hundred nm) as well as visible light (light in the range of three hundred eighty to seven hundred sixty nm) photo curing operations. The tool of the present invention includes at least a portion of the tool that is able to allow ultraviolet rays to pass through without distortion. This allows the tool to be used even while the photo-curing operation is occurring so that the fill material can be evenly compacted to eliminate voids. The fill material may shrink during the photo-curing process, thus causing voids in the fill that can lead to bacteria and other problems. The present invention is able to minimize the occurrence of voids by continuing to compact and manipulate the fill material during the curing process. Previous tools were unable to do this as the ultraviolet rays would be distorted and reflected causing damage to the surrounding tissue.

The translucent tool not only is able to transmit the ultraviolet rays without distortion, it must also be sufficient durable and hard to compact and manipulate the fill material without shattering or causing damage to the patient. The tool of the present invention also has the ability to easily shed the composite fill material, that is, the composite fill material does not adhere to the tool. This further minimizes the occurrence of voids in the cavity since the material will remain in place once it has been compacted and shaped.

The present invention, as set forth in the claims, is directed to dental tools that provide the characteristics, either individually or in combination with one another, of allowing the transmission of visible and ultraviolet wavelengths, durability and strength so that the tool is able to compact the fill material to eliminate voids and to properly shape the fill material, and non-adhesion of the fill material to the material. The claimed invention encompasses not only present materials that meet one or more of these characteristics but materials that may be developed as well that meet one or more of these characteristics.

In a preferred embodiment, discussed in greater detail below, the tool is formed, at least in part, from sapphire. It is to be expressly understood that the present invention is not limited to this material, but includes others as well. Sapphire is described herein as one material that meets the scope of the present invention.

Sapphire is an anisotropic, rhombohedral crystalline form of aluminum oxide (Al₂O₃). It occurs naturally but is also able to be synthetically created on an industrial scale. It has a high degree of transmission within the ultraviolet and visible light spectrum while possessing a high degree of strength and toughness as well as chemical resistance and composite fill material does not adhere to sapphire. Sapphire is able to transmit wavelengths between two hundred nm to seven hundred sixty nm, and even up to five μm without significant distortion. It also has a compressive strength of 20,000 kg/cm², with a tensile strength of 7,000 kg/cm², and a fracture toughness in the range of 2.4-4.5 MPA√M (Pascals per square root meters). Sapphire also has the characteristic of being slick, that is, most materials including composite fill materials will not stick or adhere to it. It also has a high abrasion resistance so it will not easily scratch which could cause distortion or reflection of wavelengths.

This provides a hard, durable tool that is capable of allowing ultraviolet rays to transmit through without distortion or reflection. This allows the tool to be used during the photo-curing process so that voids are minimized, the fill material can be more precisely shaped, and the cavity filling process be more efficiently conducted so that the patient spends less time undergoing the process. The ability of the tool to be used during the photo-curing process to prevent voids from occurring as the material shrinks, as well as the ability of the tool to shed the fill material so that it remains in place in the cavity increases the efficiency of the process. The sapphire tool is also useful prior to the photo-curing process in placing the fill material in the cavity, compacting the fill material and shaping the fill material since the fill material does not adhere to the sapphire tool and the sapphire tool has high strength and durability. The details and features of the tool of the present invention is discussed in greater details below in the description of exemplary embodiments.

### Descriptive Embodiments

A preferred embodiment of the present invention is illustrated in FIGS. 1-6. An exemplary embodiment of the dental tool 10 is illustrated in FIG. 1 for placing a fill material in tooth cavity, manipulating that fill material and compacting the fill material before and during the curing operation. This particular tool is intended to be used for use with a photo-curing application such as ultraviolet, although other light sources can be used as well. The fill material can be a composite or ionomer fill material or any other type of fill material that can be cured through photopolymerization. For descriptive terms only, the fill material is referred to as composite or polymer materials, but it is to be understood that other photo-curable materials are included as well.

The dental tool 10 includes a central gripping member 20 with distal tool ends 30, 40. The central gripping member 20 can be formed of suitable materials, preferably a material that can be easily sterilized and that does not degrade under ultraviolet light. In the preferred embodiment, the central gripping member 20 is formed of a high strength plastic with knurled portions for ease of gripping. Alternatively, the gripping member 10 could be formed from stainless steel, aluminum or other suitable materials.

The dental tool 10, of this preferred embodiment, is illustrated with opposing distal tool ends 30, 40. It is to be expressly understood that the tool could also include a single tool end as well. The tool end 30 of this preferred embodiment includes an extended distal end 32 with a reduced diameter. This reduced diameter portion 32 includes a first portion 34 that extends outwardly along the longitudinal axis of the gripping member for an extended length then a second portion 36 that angles upwardly for another length. The lengths and angle of these two portions are determined by the particulars of the teeth in order to easily access the cavity within a particular tooth while still allowing visibility to the cavity. It is to be expressly understood that other lengths, angles and configurations may be used as well within the scope of the invention as claimed.

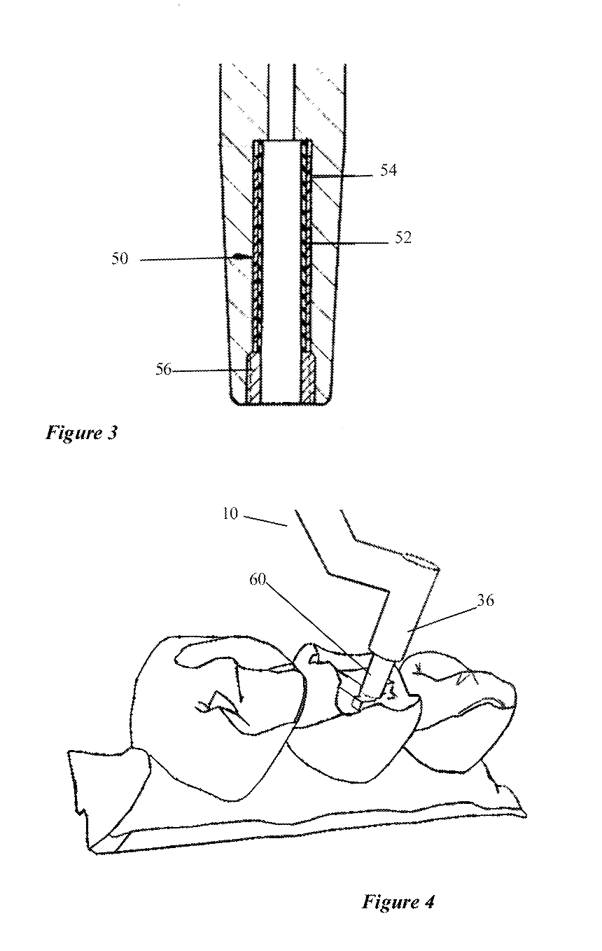

Dental tools 60, discussed in greater detail below, are secured to the tool. The tools can be formed on the tool, permanently affixed to the tool, or removably attached to the tool. In one preferred embodiment, a collet chuck 50 is affixed to the end of the tool end 32. The collet chuck 50 of this preferred embodiment enables the gripping member to be used with a variety of dental tool tips as well as replacement tips. Other fastening mechanisms may be used as well in lieu of the collect chuck, such as adhesive fasteners, cam locking mechanisms or any other fastening mechanism. It is also to be expressly understood that the tool may use permanently affixed dental tool tips as well instead of a fastening mechanism. Collet chucks are well known for securing tools and typically, as shown in FIG. 3, include an inner sleeve 52 that is radially resilient so it will compress over the dental tool tip as pressure is applied radially against it. An outer sleeve 54 having a radially tapered inner diameter extending axially down its length is slidable relative to the inner sleeve. As the inner sleeve is moved upward inside the outer sleeve, the radial taper of the inner diameter of the outer sleeve compresses the inner sleeve over the dental tool tip. A detent 56 locks the sleeves in place. The reverse operation will release the dental tool tip from the collet chuck.

The opposing end 40 of the gripping member similarly includes reduced diameter end portions 42, 44 that extend from the gripping member. These end portions may be identical to the end portions on the opposing end of the gripping member or may be at differing lengths and angles to provide a different function. A collet chuck 48 may be affixed to the distal end, or the tool tips may be permanently affixed.

The dental tool tips 60 of the present invention are uniquely designed tools that provide a combination of high strength for performing the operations of filling, manipulating and compacting the composite fill material within the cavity not only prior to the photo-curing operation but during the operation as well. It is critical that the material be properly compacted to eliminate voids and air bubbles within the fill material to prevent problems from occurring later. The dental tool tips 60 of the preferred embodiment are formed from a translucent material that will transmit ultraviolet wavelengths without reflecting or redirecting the light rays. The material must also be sufficiently durable and hard to enable the compacting and manipulation of the fill material. In this preferred embodiment, the dental tool tips are formed from sapphire. The sapphire will enable the use of the dental tool during the photo-curing operation without distorting or reflecting the ultraviolet or other light wavelengths. Further, the sapphire tool tip is relatively hard and durable so that there is no danger of shattering under use and will sufficiently compact the fill material when force is applied to eliminate any voids or air bubbles. The sapphire tool is also useful prior to the photo-curing process as the composite fill material will not adhere to it. This minimizes voids forming due to lifting or ripping of the fill material from the cavity due to adhesion to the tool.

The sapphire tool tip 60 can be formed into a cylindrical rod 62 so that it can be engaged into the collet chuck 50. The distal end 64 can be further shaped into a particular shape, as discussed in greater detail below. Alternatively, the tool tip 60 can include an intermediate portion formed from a translucent plastic material that engages in the collet chuck 50 while a sapphire tool tip 60 is affixed to the intermediate portion.

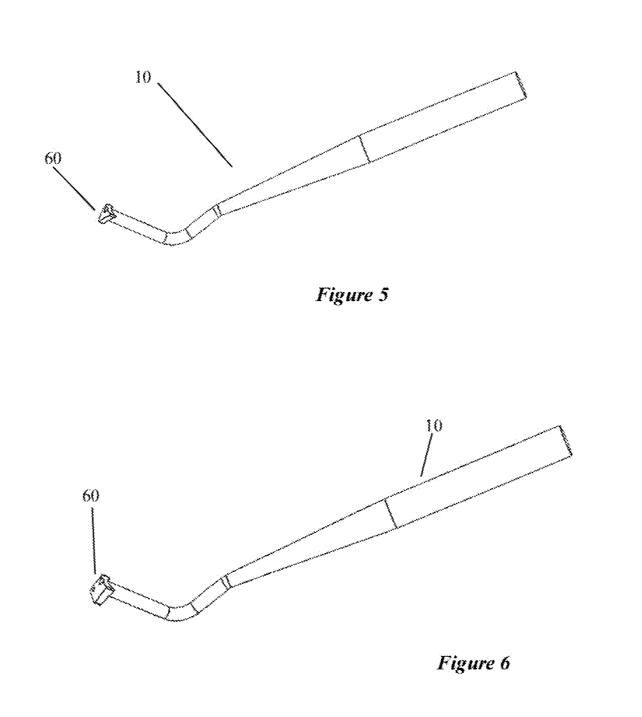

The sapphire tool tip 60 can be formed into a variety of shapes and configurations depending on the function to be accomplished and the tooth that is being filled. For example, as shown in FIGS. 5, 6, different tool tips are illustrated. Particular shapes may be used for different teeth, such as differing shapes for the bicuspids, molars, etc. as well as the locations of the teeth and location of the cavity to be filled. It is to be expressly understood that other shapes and configurations may be included within the scope of the claimed inventions.

### Use

The tooth is prepared for filling by removing any decay and shaping the cavity to receive the fill material. The fill material is applied in thin layers by depositing the material in the cavity and then manipulating it as shown in FIG. 4 with the dental tool 10. A light source (not shown) is then used to cure the fill material. The compaction and manipulation of the fill material in the cavity continues with the use of the dental tool 10 during the curing process. The ultraviolet rays are transmitted through the tool tip 60 with little or no distortion or reflection so no damage occurs to the surrounding tissue. The continued compaction and manipulation of the fill during the curing process minimizes any voids from occurring due to the shrinking of the curing material. This provides a much more efficient and reliable process than attempting to later fill voids that have occurred.

The efficiency of the cavity filling process is increased by the use of the tool and its unique combination of optical transmission so that it can be used during the photo-curing process, the hardness of the tool to compact the material to prevent voids from occurring and the ability to shed the fill material so that the fill material remains in place in the cavity. The ability of the tool to be used during the photo-curing process allows the material to be compacted and shaped as it shrinks to prevent voids from occurring increases the efficiency over previous tools that could only be used before the photo-curing process. Voids would occur with these tools as the material shrinks during curing. These voids would then have to be filled, thus increasing the time of the filling process. The hardness of the tool also minimizes voids as the material is thoroughly compacted by the tool before and during the curing process. The ability to shed the fill material also decreases the time of the filling process as the material does not cling to the tool once it has been placed. Thus, the tool of the present invention increases the efficiency of the filling process.

What is claimed is:

1. A dental tool for use in filling cavities, said tool comprising:
a tool tip for manipulating fill material within a dental cavity;
said tool tip formed from a material that transmits wavelengths between two hundred to seven hundred sixty nm without significant distortion.

2. The dental tool of claim 1 wherein said tool tip includes:
at least a portion of said tool tip allows the transmission through said portion of wavelengths between two hundred to seven hundred sixty nm without significant distortion.

3. The dental tool of claim 1 wherein said tool tip includes:
at least a portion of said tool tip allows the transmission through said portion of wavelengths between two hundred to four hundred nm without significant distortion.

4. The dental tool of claim 1 wherein said tool tip includes:
at least a portion of said tool tip allows the transmission through said portion of wavelengths between three hundred eighty to seven hundred sixty nm without significant distortion.

5. The dental tool of claim 1 wherein said tool tip includes:
at least a portion of said tool tip is formed from sapphire to allow the transmission through said sapphire portion of wavelengths between two hundred to seven hundred sixty nm without distortion.

6. The dental tool of claim 1 wherein said tool tip further includes:
said tool tip having a tensile strength of between about two hundred seventy-five MPa and four hundred MPa.

7. The dental tool of claim 1 wherein said dental tool includes:
said tool tip having a surface to which composite fill material will not adhere.

8. The dental tool of claim 1 wherein said dental tool includes:
a gripping member; and
a mechanism for removably affixing said tool tip to said gripping member.

9. The dental tool of claim 7 wherein said dental tool further includes:
a plurality of said tool tips.

10. A dental tool for use in filling cavities, said tool comprising:
a tool tip for manipulating fill material within a dental cavity; and
said tool tip formed from a material that allows wavelengths between two hundred to seven hundred sixty nm to be transmitted through said tool tip without significant distortion and a tensile strength between about two hundred seventy-five to four hundred MPa.

11. The dental tool of claim 10 wherein said tool tip includes:
said tool tip is formed of a material that allows the transmission through said portion of wavelengths between two hundred to four hundred nm without significant distortion.

12. The dental tool of claim 10 wherein said tool tip includes:
at least a portion of said tool tip allows the transmission through said portion of wavelengths between three hundred eighty to seven hundred sixty nm without significant distortion.

13. The dental tool of claim 10 wherein said tool tip includes:
at least a portion of said tool tip is formed from sapphire to allow the transmission through said sapphire portion of wavelengths between two hundred to seven hundred sixty nm without distortion.

14. The dental tool of claim 10 wherein said tool tip includes:
an outer surface that easily sheds composite fill material.

15. The dental tool of claim 10 wherein said dental tool includes:
a gripping member; and
a mechanism for removably affixing said tool tip to said gripping member.

16. The dental tool of claim 15 wherein said dental tool further includes:
a plurality of said tool tips.

17. A dental tool for use in filling cavities, said tool comprising:
a tool tip for manipulating fill material within a dental cavity; and
said tool tip formed from sapphire so that wavelengths between two hundred to seven hundred sixty nm are able to be transmitted through said tool tip without significant distortion, a tensile strength between about two hundred seventy-five to four hundred MPa and the ability to easily shed fill material.

18. The dental tool of claim 17 wherein said dental tool includes:
a gripping member; and
a mechanism for removably affixing said tool tip to said gripping member.

19. The dental tool of claim 18 wherein said dental tool further includes:
a plurality of said tool tips.
